(19) United States
(12) Patent Application Publication
(10) Pub. No.: US 2022/0277079 A1
(43) Pub. Date: Sep. 1, 2022

(54) BACKDOOR INSPECTION DEVICE, METHOD, AND NON-TRANSITORY COMPUTER-READABLE MEDIUM

(71) Applicant: NEC Corporation, Minato-ku, Tokyo (JP)

(72) Inventors: Takayuki SASAKI, Tokyo (JP); Yusuke SHIMADA, Tokyo (JP)

(73) Assignee: NEC Corporation, Minato-ku, Tokyo (JP)

(21) Appl. No.: 17/632,563

(22) PCT Filed: Aug. 9, 2019
(86) PCT No.: PCT/JP2019/031722

§ 371 Date: Feb. 3, 2022

(51) Int. Cl. G06F 21/55; G06F 21/54; G06F 21/57

(52) U.S. Cl. CPC G06F 21/556; G06F 21/54; G06F 21/554; G06F 21/577

(57) ABSTRACT

The present disclosure aims to provide a backdoor inspection device, a method, and a non-transitory computer-readable medium that are capable of detecting a code being highly likely to be a backdoor from software. A backdoor inspection device according to the present disclosure includes: a backdoor presuming means for analyzing a function and a structure of software and identifying a presumed code that is presumed to be a backdoor from the software; a data flow analysis means for analyzing a propagation state of confidential data in the software and identifying a confidential code that processes the confidential data; and a backdoor determination means for identifying a backdoor code that is more likely to be the backdoor than the presumed code, based on the presumed code and the confidential code.

### TECHNICAL FIELD

The present disclosure relates to a backdoor inspection device, a method, and a non-transitory computer-readable medium, in particular, to a backdoor inspection device, a method, and a non-transitory computer-readable medium that are capable of detecting a code being highly likely to be a backdoor from software.

### BACKGROUND ART

In recent years, infrastructures and enterprise systems that support daily lives have become complicated, and therefore such infrastructures and enterprise systems are difficult to be constructed only with devices (equipment) of a single company. Thus, devices are procured from outside suppliers, and the procured devices are combined or incorporated and constitute the infrastructure or enterprise system. When an infrastructure or an enterprise system is constructed, manufacturers of the procured devices and a manufacturing and distribution chain are handled as being assumed to be reliable. However, there have been many reports of events (incidents) in which a hidden or unexpected function that a user (a person who embeds devices) is not aware of in terms of software, firmware, and hardware of such embedded devices is found. Therefore, the assumption that the device manufacturers and the manufacturing and distribution chain are reliable is no longer valid, and, for example, a method of detecting a rogue function in software becomes necessary. Note that a term “backdoor” refers to a hidden or additional function that a user is not aware of and that is a rogue function in software.

Patent Literature 1 discloses that a binary code analyzer and a function call/system call extractor statically analyze binary codes and extract a function to be called, a system call, an API call, and argument values and conditions at a time of calling; meanwhile, a specification/definition decoder extracts a function to be called, a system call, an API call, and argument values and conditions at a time of calling from internal specifications in a case of using an internal specification document, and from external specifications and function definitions, based on an external specification document, a function definition document, a manual, and a function database in a case of using the external specification document, the function definition document, and the manual; and a valid/invalid code determiner compares both extraction results, whereby a detection result of an invalid code is output based on the comparison result.

Patent Literature 2 discloses that a method and a computing device that implements the method are configured to predict whether a software application is causing undesired behavior or behavior that degrades performance, thereby improving efficiency and performance of comprehensive behavior monitoring and an analysis system. Patent Literature 2 also discloses that the behavior monitoring and the analysis system may be configured in such a way as to quickly and efficiently classify a software application as benign by generating a behavior vector that characterizes activities of the software application, determining whether the generated behavior vector contains salient behavior or behavioral cues that identify the software application as a reliable software application, and classifying the software application as benign in response to determining that the generated behavior vector contains the salient behavior that identifies the software application as a reliable software application.

### CITATION LIST

### Patent Literature

Patent Literature 1: Japanese Unexamined Patent Application Publication No. 2009-098851

Patent Literature 2: Published Japanese Translation of PCT International Publication for Patent Application, No. 2017-504102

### SUMMARY OF INVENTION

### Technical Problem

As described above, there is a problem that a method for detecting a rogue function in software is required. In addition, there is also a problem that, when a lot of possible backdoor codes are found in software, it is necessary to prioritize the backdoors and detect a backdoor with high priority, i.e., a code that is highly likely to be a backdoor. Neither Patent Literature 1 nor Patent Literature 2 discloses a solution to these problems.

An object of the present disclosure is to provide a backdoor inspection device, a method, and a non-transitory computer-readable medium that solve any of the above-described problems.

### Solution to Problem

A backdoor inspection device according to the present disclosure includes: a backdoor presuming means for analyzing a function and a structure of software and identifying a presumed code that is presumed to be a backdoor from the software; a data flow analysis means for analyzing a propagation state of confidential data within the software and identifying a confidential code that processes the confidential data from the software; and a backdoor determination means for identifying a backdoor code that is more likely to be the backdoor than the presumed code, based on the presumed code and the confidential code.

A backdoor inspection device according to the present disclosure includes: a data flow analysis means for analyzing a propagation state of confidential data within software and identifying a confidential code that processes the confidential data from the software; a backdoor presuming means for analyzing a function and a structure of the confidential code and identifying a presumed code that is presumed to be a backdoor from the confidential code; and a backdoor determination means for identifying the presumed code as a backdoor code that is more likely to be the backdoor than the confidential code.

A method according to the present disclosure includes: analyzing a function and a structure of software and identifying a presumed code that is presumed to be a backdoor from the software; analyzing a propagation state of confidential data within the software and identifying a confidential code that processes the confidential data from the software; and identifying a backdoor code that is more likely to be the backdoor than the presumed code, based on the presumed code and the confidential code.

A non-transitory computer-readable medium according to the present disclosure stores a program that causes a computer to perform: analyzing a function and a structure of software and identifying a presumed code that is presumed to be a backdoor from the software; analyzing a propagation state of confidential data within the software and identifying a confidential code that processes the confidential data from the software; and identifying a backdoor code that is more likely to be the backdoor than the presumed code, based on the presumed code and the confidential code.

### Advantageous Effects of Invention

According to the present disclosure, it is possible to provide a backdoor inspection device, a method, and a non-transitory computer-readable medium that are capable of detecting a code being highly likely to be a backdoor from software.

### BRIEF DESCRIPTION OF THE DRAWINGS

FIG. 1 is a block diagram illustrating a backdoor inspection device according to a first example embodiment.

FIG. 2 is a block diagram illustrating the backdoor inspection device according to the first example embodiment.

FIG. 3 is a schematic diagram illustrating data flow analysis.

FIG. 4 is a schematic diagram illustrating the propagation state of confidential data within software.

FIG. 5 is a flowchart illustrating the operation of the backdoor inspection device according to the first example embodiment.

FIG. 6 is a flowchart illustrating the operation of a backdoor inspection device according to a second example embodiment.

FIG. 7 is a block diagram illustrating a backdoor inspection device according to a third example embodiment.

FIG. 8 is a flowchart illustrating the operation of the backdoor inspection device according to the third example embodiment.

FIG. 9 is a flowchart illustrating the operation of a backdoor inspection device according to a fourth example embodiment.

### DESCRIPTION OF EMBODIMENTS

The following will describe example embodiments of the present invention with reference to the drawings. In each drawing, the same or corresponding elements are designated by the same signs, and duplicate description will be omitted as necessary for clarification of the description.

### First Example Embodiment

The outline of the configuration of a backdoor inspection device according to a first example embodiment will be described.

In the first example embodiment, an example of applying the present disclosure to a backdoor of a type that causes data leakage or data rewriting will be described.

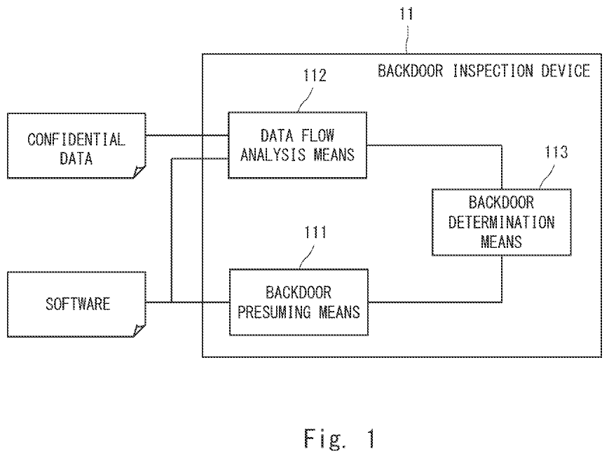

FIG. 1 is a block diagram illustrating the backdoor inspection device according to the first example embodiment.

As illustrated in FIG. 1, the backdoor inspection device 11 of the first example embodiment comprises a backdoor presuming means 111, a data flow analysis means 112, and a backdoor determination means 113.

The backdoor presuming means 111 analyzes the function and structure of software and identifies a presumed code that is presumed to be a backdoor from the software. The term “backdoor” refers to a hidden or additional function that the user who uses the equipment is not aware of and that is a rogue or undesirable function in the software. Analyzing the function and structure of software and identifying a presumed code that is presumed to be a backdoor from the software may also be referred to as “backdoor analysis.”

The data flow analysis means 112 analyzes the propagation state of confidential data within software and identifies a confidential code that processes the confidential data from the software. The confidential data may include at least one of user information (personal information and business information) of equipment in which the software is installed, a password entered in the equipment, a private key used for encryption, configuration information of the software and equipment, and information collected by the equipment in which the software is installed (temperature information in the case of a temperature sensor, image data in the case of a surveillance camera, and the like). Analyzing the propagation state of confidential data within software and identifying a confidential code that processes the confidential data from the software may be referred to as “data flow analysis.”

The backdoor determination means 113 identifies a backdoor code that is more likely to be a backdoor than the presumed code, based on the presumed code and the confidential code. That is, the backdoor determination means 113 identifies a backdoor code that is more likely to operate as a backdoor than the presumed code.

In this way, a backdoor code that is identified as a code having a high possibility of being a backdoor can be inspected with higher priority. As the result, according to the first example embodiment, it is possible to provide a backdoor inspection device that can detect a code that is highly likely to be a backdoor.

Note that the code may be a source code or an execution code. A plurality of codes may be collectively referred to as a code block. Confidential data may also be referred to as confidential information.

The details of the configuration of the backdoor inspection device according to the first example embodiment will be described.

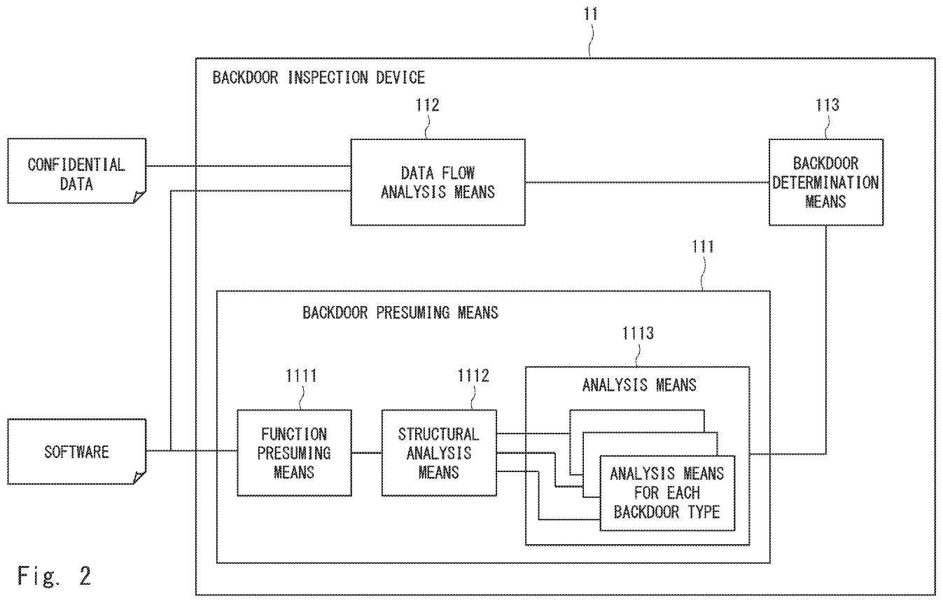

FIG. 2 is a block diagram illustrating the backdoor inspection device according to the first example embodiment.

FIG. 2 illustrates the details of FIG. 1.

As illustrated in FIG. 2, the backdoor presuming means 111 of the backdoor inspection device 11 includes a function presuming means 1111, a structural analysis means 1112, and an analysis means 1113.

The function presuming means 1111 presumes a specific function, such as an interface function, an authentication function, and a command parser function, in software.

The structural analysis means 1112 reveals the structure of the entire software, based on a control flow, starting from the presumed specific function. Specifically, the structural analysis means 1112 extracts a plurality of functions included in the control flow and presumes each function. The structural analysis means 1112 separates the presumed functions by type.

The analysis means 1113 has an analysis means for each type of backdoor. The analysis means 1113 uses the analysis means for each type of backdoor to compare the separated function and the backdoor associated to the function for each type of backdoor. As the result of the comparison, the analysis means 1113 presumes whether the function is a backdoor and identifies a presumed code that is presumed to be a backdoor from the software.

Herein, the data flow analysis will be described.

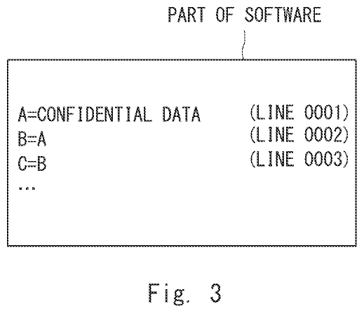

FIG. 3 is a schematic diagram illustrating the data flow analysis.

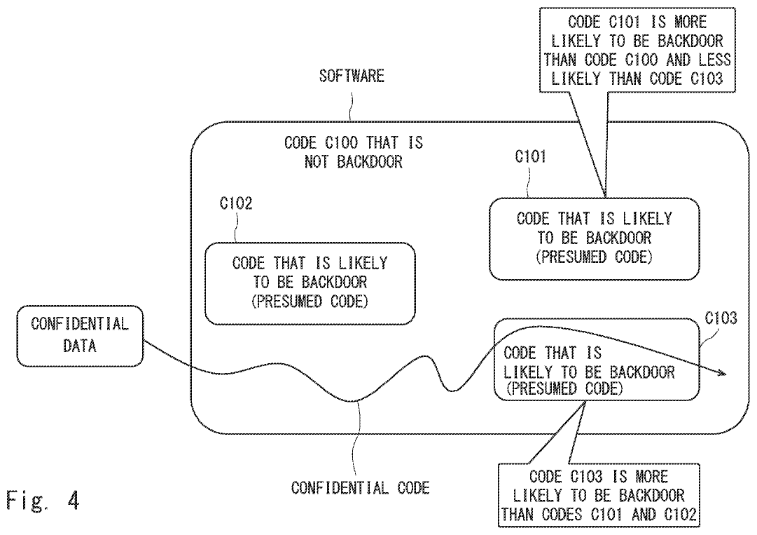

FIG. 4 is a schematic diagram illustrating the propagation state of confidential data within software.

The data flow analysis is analyzing which code block manipulates or propagates the value of a particular variable using Control Flow Graph (CFG), or the like. For example, as illustrated in FIG. 3, confidential data is assigned to A in line 0001 of the software (A=confidential data). A is assigned to B in line 0002 (B=A). B is assigned to C in line 0003 (C=B). In this way, confidential data propagates from A to C within the software.

As illustrated in FIG. 4, the backdoor presuming means 111 presumes possible backdoor codes C101, C102, and C103. The data flow analysis means 112 acquires the propagation path of confidential data and identifies a confidential code that processes the confidential data, based on the propagation path of the confidential data within the software as illustrated in FIG. 3.

The backdoor highly likely causes data leakage and data rewriting for confidential data that is important data. Therefore, in FIG. 4, a common code part between a code that is likely to be a backdoor (a presumed code) and the confidential code is a code having a high possibility of being a backdoor. Specifically, in FIG. 4, since the code C103 overlaps and has a common part between the presumed code and the confidential code, the possibility of being a backdoor is considered to be higher than the codes C101 and C102.

Thus, the backdoor determination means 113 of the backdoor inspection device 11 identifies the common part between the presumed code and the confidential code as a backdoor code.

On the other hand, codes C101 and C102 are considered more likely to be a backdoor than code C100, which is not a backdoor, and less likely to be a backdoor than code C103.

Note that the backdoor inspection device 11 may further comprise an acquisition means (not illustrated) for acquiring confidential data from outside and a storage means (not illustrated) for storing the confidential data.

The backdoor inspection device 11 may also be included in a general software analysis device that analyzes software. In such a case, the backdoor inspection device may be referred to as a software analysis device.

The features of a method of the first example embodiment will be described as follows:
The backdoor inspection device 11 acquires confidential data including personal information, a password, or the like from an external analyst. At this time, information about the confidential data, for example, information on a location where the confidential data is stored may be acquired. Specifically, when an analysis target is a source code, a variable in which the confidential data is stored may be acquired. Further, when the analysis target is an execution code, information such as a register and memory address where the confidential data is stored may be acquired.
The backdoor inspection device 11 performs backdoor analysis to identify a presumed code that is presumed to be a backdoor.
The backdoor inspection device 11 performs data flow analysis and analyzes the propagation state of confidential data within the software.
The backdoor inspection device 11 acquires a common part between the presumed code that is determined to be a backdoor as the result of the backdoor analysis and the confidential code that is determined to process the confidential data as the result of the data flow analysis.
The backdoor inspection device 11 identifies the acquired common part as a backdoor code.

The operation of the backdoor inspection device according to the first example embodiment will be described.

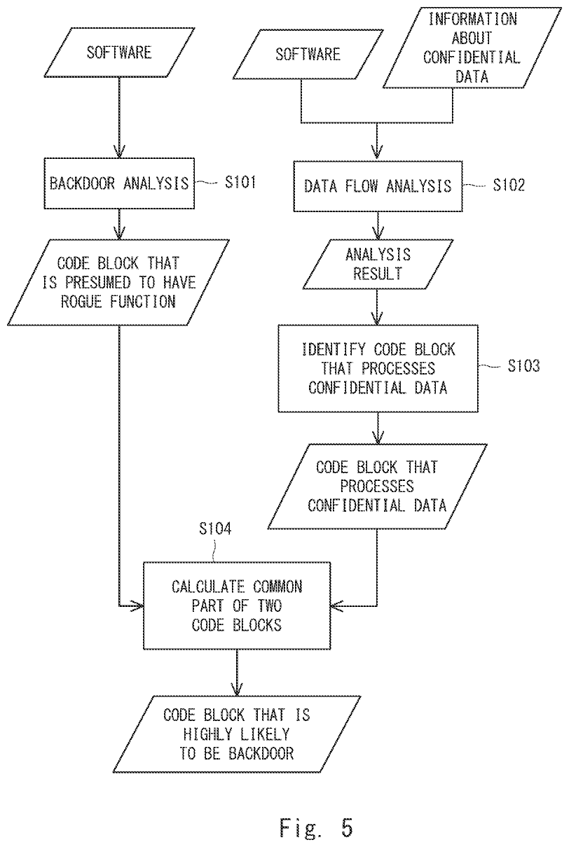

FIG. 5 is a flowchart illustrating the operation of the backdoor inspection device according to the first example embodiment.

As illustrated in FIG. 5, the backdoor inspection device 11 performs backdoor analysis on software of equipment (Step S101).

The backdoor inspection device 11 identifies a code block (a presumed code) that is presumed (judged) to be a rogue function, that is, a backdoor, from the software as the result of step S101.

The backdoor inspection device 11 performs data flow analysis, based on the information about the software and the confidential data (Step S102).

As the result of the data flow analysis, the backdoor inspection device 11 identifies a code block (a confidential code) that processes the confidential data (Step S103).

The backdoor inspection device 11 calculates a common part of two code blocks: the code block that is presumed to be a backdoor (a rogue function) and the code block that processes confidential data (Step S104).

Since the common part of the two code blocks is more likely to be a backdoor, the backdoor inspection device 11 identifies the common part as a backdoor code. That is, the backdoor inspection device 11 identifies a common part with the confidential code that processes the confidential data, among the presumed code that is likely to be a specific backdoor as the result of the backdoor analysis, and identifies this common part as a backdoor code.

### Second Example Embodiment

A backdoor will not be executed unless an activation condition for triggering the backdoor is set, and, in such a case, data flow analysis may not be possible. The following is a description of a second example embodiment, which makes it possible to detect a code that is highly likely to be a backdoor even in such a case.

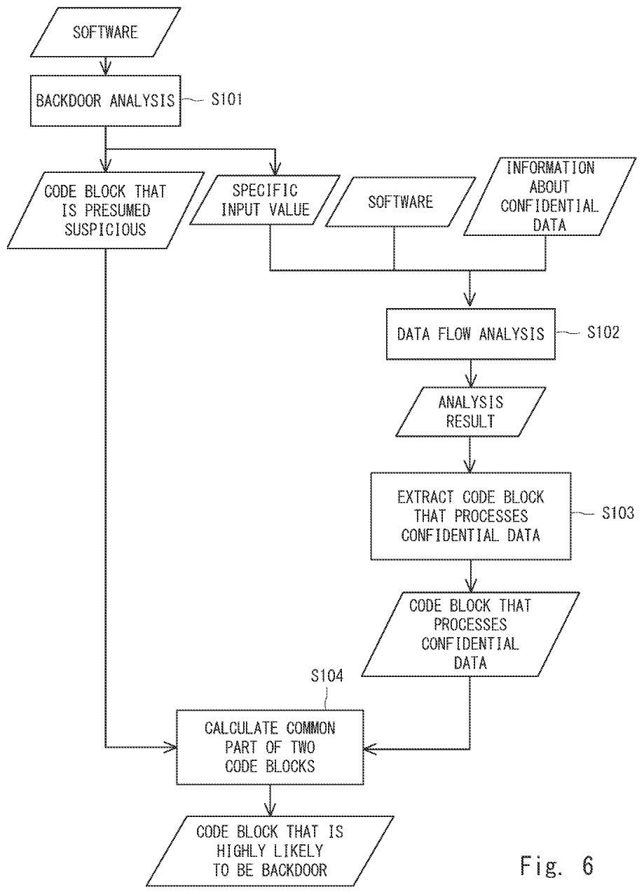

FIG. 6 is a flowchart illustrating the operation of the backdoor inspection device according to the second example embodiment.

As illustrated in FIG. 6, the backdoor inspection device according to the second example embodiment differs from the backdoor inspection device 11 according to the first example embodiment in that a backdoor activation condition is used in backdoor analysis. The activation condition may also be referred to as the trigger condition.

The backdoor inspection device according to the second example embodiment acquires a specific input value by backdoor analysis (Step S101). The specific input value is an activation code relating to an activation condition of a backdoor. That is, the backdoor inspection device identifies an activation code relating to an activation condition of a backdoor from software.

In the data flow analysis of step S102, the backdoor inspection device sets the activation code and executes the backdoor, then, identifies a confidential code during execution of the backdoor. That is, the backdoor inspection device performs data flow analysis under the condition under which the backdoor is being executed.

In the operation of the backdoor inspection device according to the second example embodiment, the operation other than the above is the same as that of the backdoor inspection device 11 according to the first example embodiment.

A backdoor is not executed unless an activation code is set, and, in such a case, data flow analysis may not be possible. Even in such a case, the backdoor inspection device according to the second example embodiment can detect a backdoor code that is highly likely to be a backdoor, since the backdoor inspection device sets an activation code and executes the backdoor to perform data flow analysis.

### Third Example Embodiment

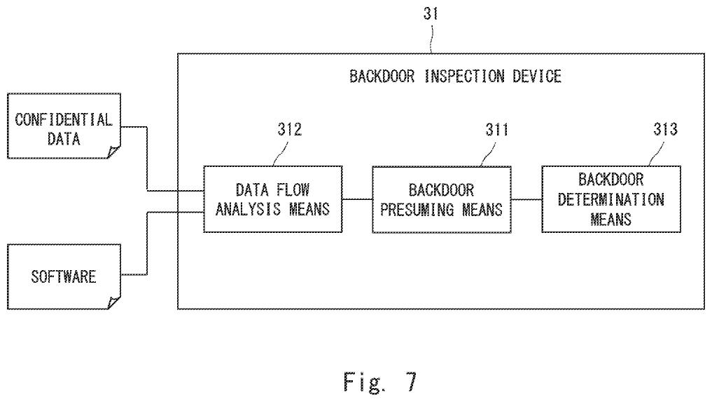

FIG. 7 is a block diagram illustrating a backdoor inspection device according to a third example embodiment.

As illustrated in FIG. 7, the backdoor inspection device 31 of the third example embodiment comprises a data flow analysis means 312, a backdoor presuming means 311 and a backdoor determination means 313.

The data flow analysis means 312 analyzes the propagation state of confidential data within software and identifies a confidential code that processes the confidential data from the software.

The backdoor presuming means 311 analyzes the function and structure of the confidential code and identifies a presumed code that is presumed to be a backdoor from the confidential code.

The backdoor determination means 313 identifies a presumed code as a backdoor code that is more likely to be a backdoor than the confidential code.

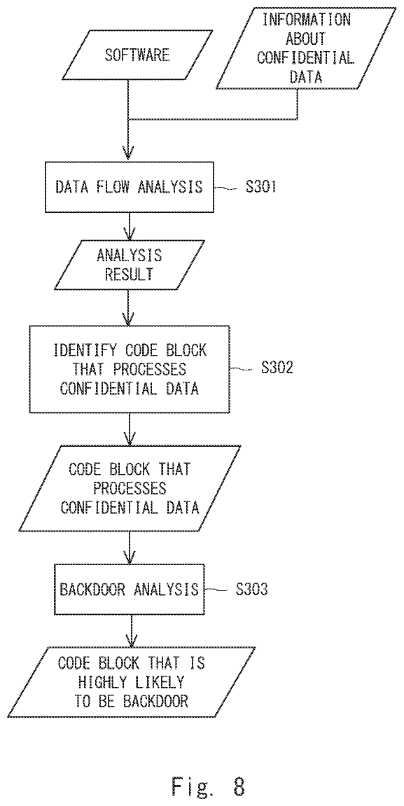

FIG. 8 is a flowchart illustrating the operation of the backdoor inspection device according to the third example embodiment.

As illustrated in FIG. 8, the backdoor inspection device 31 according to the third example embodiment performs data flow analysis, based on the information about software and confidential data (Step S301).

As the result of the data flow analysis, the backdoor inspection device 31 identifies a code block (a confidential code) that processes the confidential data (Step S302).

The backdoor inspection device 31 performs backdoor analysis on the code block identified as being a confidential code that processes the confidential data, and identifies a code block that is highly likely to be a backdoor (Step S303).

The backdoor inspection device 31 according to the third example embodiment does not perform backdoor analysis (inspection) on the entire software, but only on a code block that is identified as a confidential code. In this way, compared with a case of performing backdoor analysis on the entire software, it is possible to reduce time to identify a code block that is highly likely to be a backdoor.

### Fourth Example Embodiment

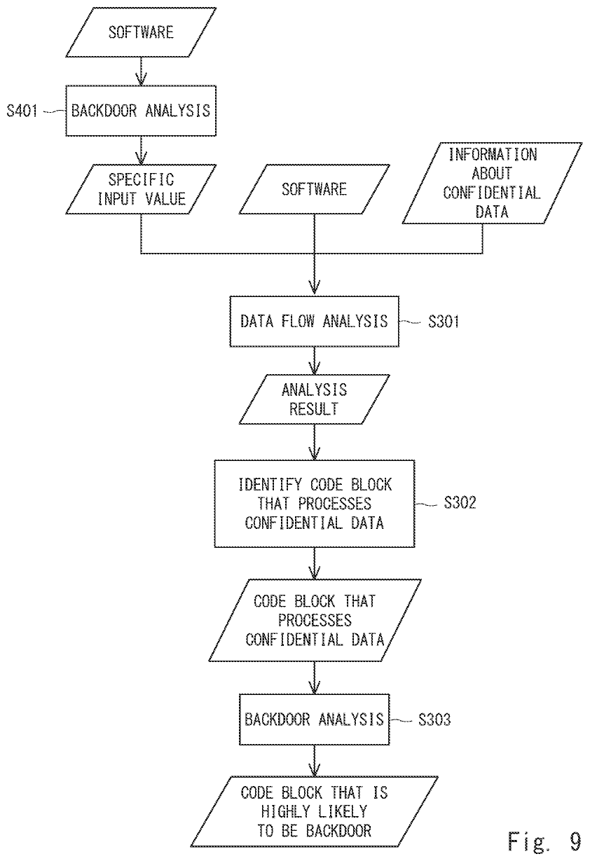

FIG. 9 is a flowchart illustrating the operation of a backdoor inspection device according to a fourth example embodiment.

As illustrated in FIG. 9, the backdoor inspection device according to the fourth example embodiment differs from the backdoor inspection device 31 according to the third example embodiment in that a backdoor activation condition is used in the backdoor analysis.

The backdoor inspection device according to the fourth example embodiment acquires a specific input value by backdoor analysis (Step S401). The specific input value is an activation code relating to an activation condition of a backdoor. That is, the backdoor inspection device identifies an activation code relating to an activation condition of a backdoor from software.

In the data flow analysis of step S301, the backdoor inspection device sets an activation code and executes the backdoor, then, identifies a confidential code during execution of the backdoor. That is, the backdoor inspection device performs data flow analysis under the condition under which the backdoor is being executed.

In the operation of the backdoor inspection device according to the fourth example embodiment, the operation other than the above is the same as that of the backdoor inspection device 31 according to the third example embodiment.

A backdoor is not executed unless an activation code is set, and, in such a case, data flow analysis may not be possible. Even in such a case, the backdoor inspection device according to the fourth example embodiment can detect a backdoor code that is highly likely to a be backdoor, since the backdoor inspection device sets an activation code and executes the backdoor to perform data flow analysis.

Although the present invention has been described as a hardware configuration in the above example embodiments, the present invention is not limited thereto. The present invention can also be realized by causing a CPU (Central Processing Unit) to execute a computer program for processing of each component.

The above-described program is stored using any of various types of non-transitory computer-readable media and can be supplied to a computer. The non-transitory computer-readable media include various types of tangible storage media. Examples of non-transitory computer-readable media include magnetic storage media (specifically, flexible disks, magnetic tapes, and hard disk drives), magneto-optical storage media (specifically, magneto-optical disks), CD-ROM (Read Only Memory), CD-R, CD-R/W, CD-R/W, semiconductor memory (specifically, mask ROM, PROM (Programmable ROM), EPROM (Erasable PROM)), flash ROM, and RAM (Random Access Memory). The program may also be supplied to a computer through any of various types of transitory computer-readable media. Examples of the transitory computer-readable media include electrical, optical, and electromagnetic waves. The transitory computer-readable media can supply the program to the computer via a wired communication path, such as an electric wire and an optical fiber, or a wireless communication path.

Although the present invention has been described with reference to the example embodiments described above, the present invention is not limited by the above. Various changes that can be understood by those skilled in the art can be made to the configuration and details of the present disclosure within the scope of the present invention.

Note that the present invention is not limited to the above-described example embodiments, and may be changed as appropriate without departing from the principle of the present invention.

### REFERENCE SIGNS LIST

11, 31 Backdoor inspection device
111, 311 Backdoor presuming means
1111 Function presuming means
1112 Structural analysis means
1113 Analysis means
112, 312 Data flow analysis means
113, 313 Backdoor determination means
C100, C101, C102, C103 Code

What is claimed is:

1. A backdoor inspection device comprising:
at least one memory storing instructions, and
at least one processor configured to execute the instructions to;
analyze a function and a structure of software and identify a presumed code that is presumed to be a backdoor from the software;
analyze a propagation state of confidential data within the software and identify a confidential code that processes the confidential data from the software; and
identify a backdoor code that is more likely to be the backdoor than the presumed code, based on the presumed code and the confidential code.

2. The backdoor inspection device according to claim 1, wherein the at least one processor is configured to identify a common part between the presumed code and the confidential code as the backdoor code.

3. The backdoor inspection device according to claim 1, wherein
the at least one processor is configured to identify an activation code relating to an activation condition of the backdoor from the software, and
the at least one processor is configured to set the activation code, execute the backdoor, and then, identify the confidential code during execution of the backdoor.

4. The backdoor inspection device according to claim 1, the at least one processor configured to execute the further instructions to;
acquire the confidential data from outside; and
store the confidential data.

5. The backdoor inspection device according to claim 1, wherein the confidential data include at least one of user information of equipment in which the software is installed and a password to be entered into the equipment.

6. The backdoor inspection device according to claim 1, wherein the at least one processor is configured to identify the confidential code, based on a propagation path of the confidential data within the software.

7. A backdoor inspection device comprising:
at least one memory storing instructions, and
at least one processor configured to execute the instructions to;
analyze a propagation state of confidential data within software and identify a confidential code that processes the confidential data from the software;
analyze a function and a structure of the confidential code and identify a presumed code that is presumed to be a backdoor from the confidential code; and
identify the presumed code as a backdoor code that is more likely to be the backdoor than the confidential code.

8. The backdoor inspection device according to claim 7, wherein
the at least one processor is configured to identify an activation code relating to an activation condition of the backdoor from the software, and
the at least one processor is configured to set the activation code, executes the backdoor, and then, identify the confidential code during execution of the backdoor.

9. A method comprising:
analyzing a function and a structure of software and identifying a presumed code that is presumed to be a backdoor from the software;
analyzing a propagation state of confidential data within the software and identifying a confidential code that processes the confidential data from the software; and
identifying a backdoor code that is more likely to be the backdoor than the presumed code, based on the presumed code and the confidential code.

10. A non-transitory computer-readable medium that stores a program that causes a computer to perform:
analyzing a function and a structure of software and identifying a presumed code that is presumed to be a backdoor from the software;
analyzing a propagation state of confidential data within the software and identifying a confidential code that processes the confidential data from the software; and
identifying a backdoor code that is more likely to be the backdoor than the presumed code, based on the presumed code and the confidential code.
